(19) United States
(12) Patent Application Publication
(10) Pub. No.: US 2004/0124046 A1
(43) Pub. Date: Jul. 1, 2004

(54) Separable brake rotor

(76) Inventors: Brian David Hayes, Newark, OH (US); Robert J. Martin III, Newark, OH (US); Tomaz Dopico Varela, Gahanna, OH (US)

Correspondence Address: CARLSON, GASKEY & OLDS, P.C., 400 WEST MAPLE ROAD, SUITE 350, BIRMINGHAM, MI, 48009, US

(21) Appl. No.: 10/331,316

(22) Filed: Dec. 30, 2002

(51) Int. Cl. F16D 65/10

(52) U.S. Cl. 188/218 XL

(57) ABSTRACT

A disc brake system includes a hub having a plurality of extensions and a multi-portion rotor which can be separated without disturbing the hub, bearing or other axle assemblies. The extensions engage the brake rotor assembly to transfer braking torque between the rotor assembly and the hub. Each extension is received between abutments which extend from an inner surface of the brake rotor portions opposite the engagement surface which contacts a brake pad. Threaded fasteners and hollow concentric bushings are mounted transverse the parting line to mount the brake rotor portions together. Another disc brake assembly includes four extensions arranged in a cruciform pattern about the hub. An offset parting line allows for an angled approach of the joint between the assembled rotor portions as it rotates into brake pads to provide less wear from any potential joint mismatch. A clearance is defined between the assembled rotor disc and the hub to reduce the tendency of the rotor to twist under load and because of the lack of requirement for a pilot, reduces the heat transfer to the hub bearings and improves air flow to the rotor.

### BACKGROUND OF THE INVENTION

The present invention relates to a disc brake system and more particularly to a multi-portion serviceable brake rotor and hub assembly.

Vehicles such as commercial vehicles require heavy-duty brake systems which can withstand high stresses during braking. Disc brakes provide many advantages for commercial vehicles and are being utilized for a multiple of axle designs.

Some axle designs require that disc brake rotors be mounted in such a manner that may make removal for service relatively difficult and/or time consuming. In one axle design, the planetary hub must be dismantled in order to remove the rotor. In commercial service, rotor changes are expected many times in the vehicle's service life, thus making such an arrangement problematic.

In many axle designs, the rotor disc is mounted with an offset to allow a simple ventilation arrangement between the rotor surfaces. However, rotor life may be decreased with such fixed rotors with offset attachment arrangements as compared to rotors that are attached “in plane” and are allowed some measure of axial float. Heat transfer to the wheel bearings may also be a problem with disc brakes, especially permanently lubricated “unitized” wheel bearings used in “stop-and-go” traffic.

Accordingly, it is desirable to provide a brake rotor assembly which is readily serviceable, allows axial float and minimizes the transfer of heat to the wheel bearings.

### SUMMARY OF THE INVENTION

The disc brake system according to the present invention provides a hub having a plurality of extensions which extend radially relative an axis of rotation. The extensions engage a multi-portion brake rotor assembly to transfer braking torque between the rotor assembly and the hub.

A first brake rotor portion is mounted to a second brake rotor portion about the axis of rotation along a parting line which is rotationally offset from the abutments. Threaded fasteners and hollow, concentric bushings are mounted transverse the parting line to mount the brake rotor portions together to form a complete brake rotor. Maintenance is greatly simplified as the brake rotor can be separated in a relatively short time period without disturbing the hub, bearing or other axle assemblies. A spring clip is mounted to each extension to compensate for a loose fit of the extension between the abutments, provide for slight axial “float” of the rotor assembly to improve rotor and pad wear characteristics and also provide an “anti-clunk” function when the brakes are applied in reverse.

Another disc brake system includes four extensions arranged in a cruciform pattern about the hub. Each rotor portion includes a complete pair of abutments and one abutment from two pairs of abutments which span an offset parting line. The offset parting line allows for an angled approach of the joint between the assembled rotor portions as the rotor rotates relative the brake pads to provide less wear from any potential joint mismatch. The offset parting line also provides a complete inner surface of the brake rotor portions for facial engagement of the extensions received between the two pairs of abutments which span the parting line.

Spring clips provide a positive centering method for the rotor disc and provide a clearance between the assembled rotor disc and the hub to reduce the tendency of the rotor to twist under caliper load. Avoidance of a pilot engagement also reduces the heat transfer to the hub bearings and improves air flow to the rotor.

The present invention therefore provides a brake rotor assembly which is readily serviceable, allows axial float and minimizes the transfer of heat to the wheel bearings.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general perspective view of an exemplary view of a vehicle axle assembly having a disc brake system for use with the present invention;

FIG. 2 is a perspective view of a disc brake system according to the present invention;

FIG. 3 is a sectional view of the disc brake system taken along line 3-3 in FIG. 2;

FIG. 4 is an exploded view of another disc brake system; and

FIG. 5 is a perspective view of the disc brake system of FIG. 4 in an assembled partially sectioned condition.

### DETAILED DESCRIPTION OF THE PREFERRED EMBODIMENT

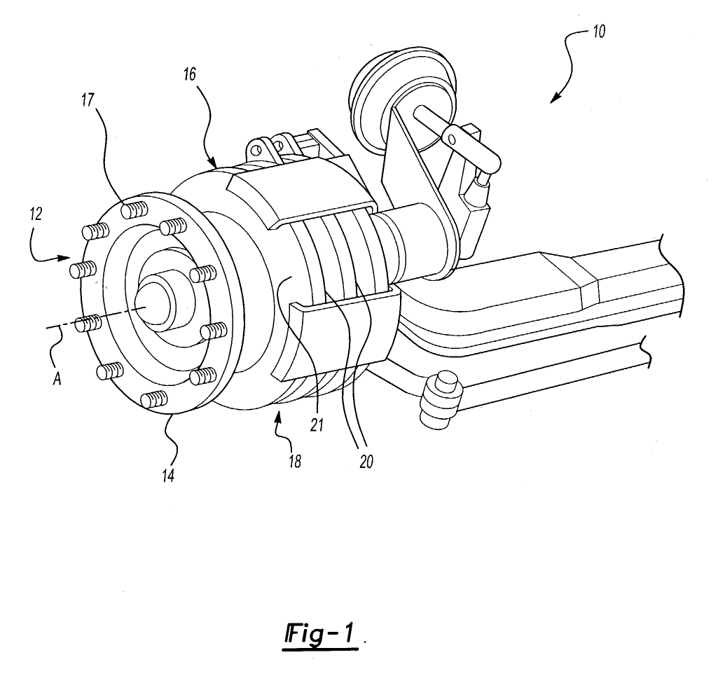

FIG. 1 illustrates a general perspective view of a vehicle axle assembly 10 having a disc brake system 12 attached thereto. It should be understood that the disc brake system should not be limited to the illustrated embodiment and that various mounting methods, caliper mounts and axle assemblies will benefit from the present invention.

The disc brake system 12 generally includes a wheel hub 14 which rotates about an axis of rotation A. The hub 14 mounts a disc brake rotor assembly 16 for unitary rotation with one or more wheels (not shown) attached to the hub 14 through fasteners 17 or the like. A brake caliper 18 drives brake pads 20 into engagement with an engagement surface 21 of the rotor assembly 16 to slow rotation of the hub 14 as generally known.

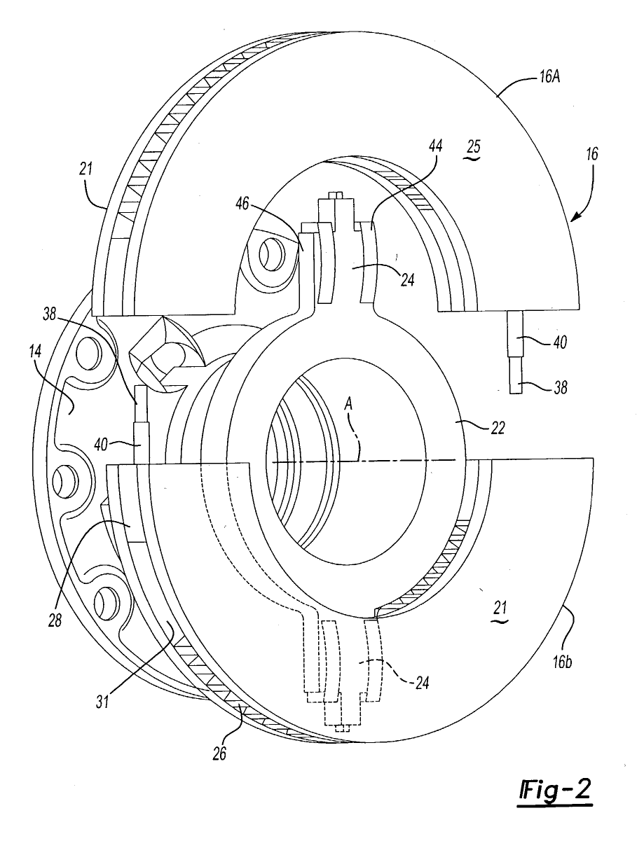

Referring to FIG. 2, the wheel hub 14 preferably includes a brake rotor mounting hub 22 attached thereto. The brake rotor mounting hub 22 may be integrally formed or separately mounted to the wheel hub 14 by various arrangements. The hub 22 includes a plurality of extensions 24 which extend radially relative the axis of rotation A. The extensions 24 extend in a cantilevered manner and are preferably flat polygonal members which receive a first brake rotor portion 16a and a second brake rotor portion 16b. That is, the extensions 24 engage the brake rotor portions 16a, 16b to transfer braking torque between the rotor assembly 16 and the hub 22.

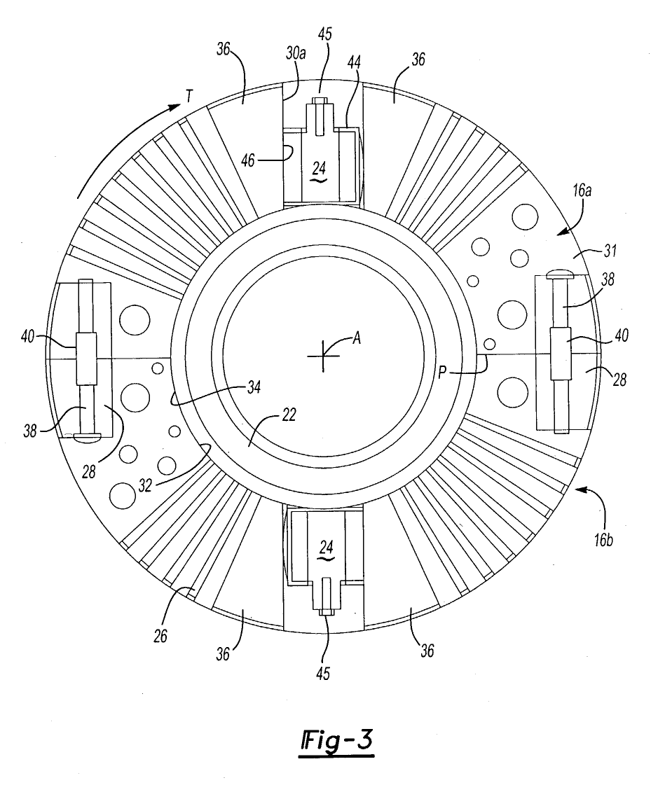

Referring to FIG. 3, engagement between the rotor assembly 16 and the hub 22 is illustrated. Various cooling vanes 26 and support structure 28 extend from the inner surface 31 (also illustrated in FIG. 2) to assist in cooling of the rotor assembly 16. That is, the engagement surface 21 (FIG. 2) of each rotor of the rotor assembly 16 are separated and vented by the structure 26, 28 extending from the inner surfaces 31.

The rotor assembly 16 defines an inner diameter opening 32 which closely fits about an outer diameter 34 of the hub 22. Each extension 24 is received between a pair of abutments 36 which extend from the inner surface 31 of the brake rotor portions 16a, 16b opposite the engagement surface 21 (FIG. 2). That is, each pair of abutments 36 captures a respective extension 24 to transfer braking torque between the rotor assembly 16 and the hub 22.

The second brake rotor portion 16b is mounted to the first brake rotor portion 16a about the axis of rotation A along a parting line P which is rotationally offset preferably 90 degrees from the from the pairs of abutments 30. A threaded fastener 38 and hollow, concentric bushing 40 are preferably mounted transverse the parting line P to mount the second brake rotor portion 16b to the first brake rotor portion 16a (also illustrated in FIG. 2). Maintenance is greatly simplified as the brake rotor can be separated in a relatively short time period without disturbing the hub, bearing or other axle assemblies.

The bushings 40 are press fitted into support structure 28 to minimize wear-causing joint mismatch when the rotor portions 16a, 16b are assembled. The bushings 40 closely fit into counterbores 42 to operate as locating posts. The rotor portions 16a, 16b are preferably assembled and final machining is performed as a unit to provide a smooth and continuous engagement surface 21 (FIG. 2).

Each pair of abutments 36 may capture the respective extension 24 with a relatively loose fit to ease assembly and machining tolerances. A spring clip 44 is preferably mounted to each extension 24 by a fastener 45 or the like. The spring clip 44 preferably extends over three faces of the extension 24 (also illustrated n FIG. 2). An extension radial face 46 engages an abutment face 30a without a portion of the spring clip 44 therebetween when braking torque (illustrated schematically by arrow T) is applied. In other words, the faces 46, 30a are biased together by spring clip 44. The spring clips 44 compensate for loose fit and provide for slight axial “float” of the rotor assembly 16 to improve rotor and pad wear characteristics and also provide an “anti-clunk” function when the brakes are applied in reverse.

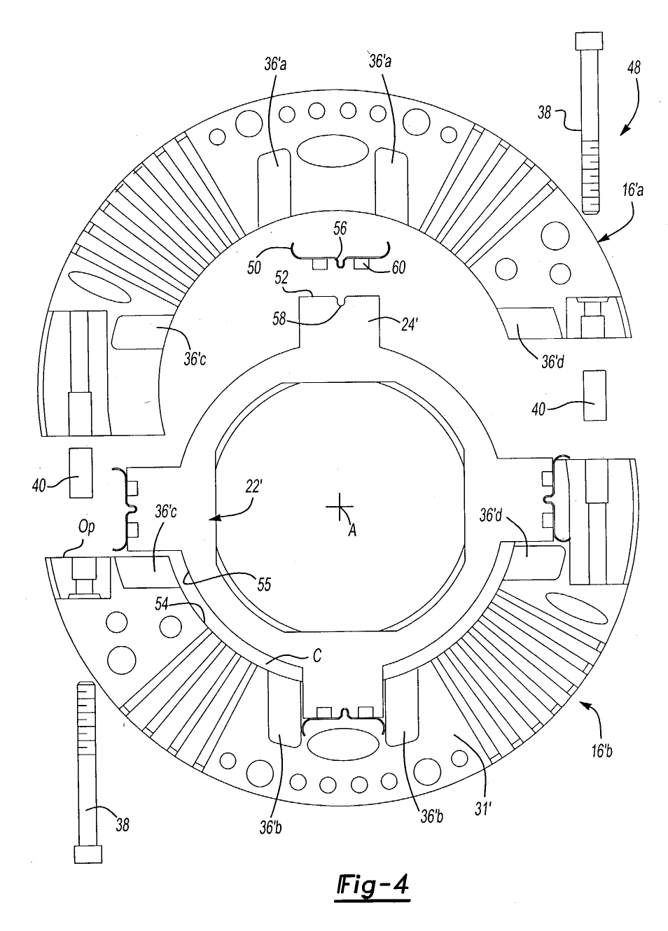

Referring to FIG. 4, another disc brake assembly 48 is illustrated. Components common to disc brake system 12 and disc brake assembly 48 will not be described and operation of the common components are generally comparable.

The hub 22′ of disc brake assembly 48 includes four extensions 24′ arranged in a cruciform pattern. Each rotor portion 16′a, 16′b include four abutments 36′. Preferably, each rotor portion 16′a, 16′b includes a complete pair of abutments 36′a, 36′b and one abutment from the two pair of abutments 36′c, 36′d which span an offset parting line Op. The offset parting line Op allows for an angled approach of the joint between rotor portions 16′a, 16′ as it rotates into pad positions which provide less wear from any potential joint mismatch. That is, the brake pad approaches the joint at an oblique angle and separately as the joint does not form a line which passes through the axis of rotation A. The offset parting line Op also provides a complete inner surface 31′ of the brake rotor portions 16′a, 16′b for facial engagement of the extensions 24′ received between the two pair of abutments 36′c, 36′d.

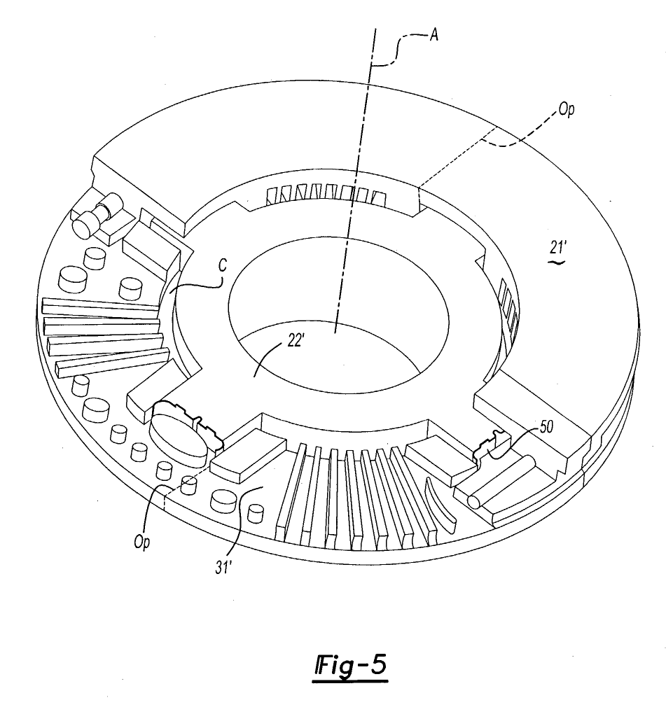

Spring clips 50 preferably span each pair of abutments 36′a, 36′b, 36′c, 36′d and engage a cantilever end 52 of the extensions 24′ which fits therebetween (also illustrated in FIG. 5). The spring clips 50 provide a positive centering method for the rotor disc 16′ without the use of a traditional pilot. That is, a clearance C is defined between an inner diameter 54 of the assembled rotor disc 16′ and an outer diameter 55 of the hub 22′. This arrangement, because of the lack of requirement for a pilot, reduces the heat transfer to the hub bearings and improves air flow to the rotor.

Each pair of abutments 36′a, 36′b, 36′c, 36′d may capture the respective extension 24′ with a relatively loose fit as each spring clip 50 is preferably “{” shaped to center each extension 24′ between its respective pair of abutments 36′a, 36′b, 36′c, 36′d. It should be understood that various other spring clip designs will also benefit from the present invention.

Each spring clip 50 includes a key 56 which fits into a corresponding slot 58 in the center of the cantilever end 52 of each extensions 24′ to center each extension 24′ between a respective pair of abutments 36′a, 36′b, 36′c, 36′d. A locating member 60 of each spring clip 50 locates each extension 24′ axially along the axis of rotation A. The locating members 60 extend along an axial face of the extension parallel to an inner surface 31′ of the brake rotor portions 16′a, 16′b opposite the engagement surface 21′ (FIG. 5). Spring clips 50 compensate for the relatively loose fit between abutment pairs and also provide an “anti-clunk” function through when the brakes are applied through key 56. Spring clips 50 also provide for slight axial “float” of the rotor assembly 16 through locating members 60 to improve rotor and pad wear characteristics.

It should be understood that although two and four extensions are illustrated in the disclosed embodiments, any number of extensions will benefit from the present invention. Also, although continuous abutments are disclosed, discontinuous abutments and other engagement surfaces will benefit from the present invention. Various biasing members other than spring clips may also be utilized to center and float the hub within the rotor in light of the above teachings.

The foregoing description is exemplary rather than defined by the limitations within. Many modifications and variations of the present invention are possible in light of the above teachings. The preferred embodiments of this invention have been disclosed. However, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A disc brake assembly comprising:
a hub defining an axis of rotation, said hub comprising a plurality of extensions which extend radially relative said axis of rotation;
a first brake rotor portion comprising a first pair of abutments which engage one of said plurality of extensions; and
a second brake rotor portion comprising a second pair of abutments which engage one of said plurality of extensions, said second brake rotor portion mounted to said first brake rotor portion about said axis of rotation.

2. The disc brake assembly as recited in claim 1, wherein said first brake rotor portion joins said second brake rotor portion along an offset parting line.

3. The disc brake assembly as recited in claim 1, wherein said first brake rotor portion joins said second brake rotor portion along an offset parting line, said offset parting line located adjacent one of said first pair of abutments and one of said second pair of abutments, said one of said first pair of abutments parallel and offset to said one of said second pair of abutments.

4. The disc brake assembly as recited in claim 1, wherein said first brake rotor portion joins said second brake rotor portion along a parting line rotationally offset from said first and second pairs of abutments.

5. The disc brake assembly as recited in claim 1, further comprising a threaded fastener which joins said first brake rotor portion to said second brake rotor portion, said threaded fastener locatable transverse to a parting line defined between said first brake rotor portion to said second brake rotor portion.

6. The disc brake assembly as recited in claim 5, further comprising a hollow bushing which receives said threaded fastener.

7. The disc brake assembly as recited in claim 6, wherein said hollow bushing located transverse to said parting line.

8. The disc brake assembly as recited in claim 1, further comprising a spring clip which engages one of said first pair of abutments and said one of said plurality of extensions.

9. The disc brake assembly as recited in claim 8, wherein said spring clip extends radially along at least one side of said one of said plurality of extensions.

10. The disc brake assembly as recited in claim 1, further comprising a spring clip which engages said first pair of abutments and said one of said plurality of extensions.

11. The disc brake assembly as recited in claim 10, wherein said spring clip extends between said first pair of abutments.

12. The disc brake assembly as recited in claim 10, wherein said spring clip engages a cantilever end of said one of said plurality of extensions.

13. The disc brake assembly as recited in claim 1, wherein said first brake rotor portion and said second brake rotor portion float relative said hub upon a spring bias.

14. The disc brake assembly as recited in claim 1, wherein said first brake rotor portion and said second brake rotor portion define a clearance about said hub.

15. A disc brake assembly comprising:
a hub defining an axis of rotation, said hub comprising a first and a second extension which extend radially relative said axis of rotation;
a first brake rotor portion comprising a first pair of abutments which engage said first extension;
a second brake rotor portion comprising a second pair of abutments which engage said second extension, said second brake rotor portion joined to said first brake rotor portion about said axis of rotation along a parting line rotationally offset from said first and second pairs of abutments;
a first spring clip between said first extension and one of said first pair of abutments; and
a second spring clip between said second extension and one of said second pair of abutments.

16. The disc brake assembly as recited in claim 15, further comprising a threaded fastener which joins said first brake rotor portion to said second brake rotor portion, said threaded fastener locatable transverse to said parting line.

17. The disc brake assembly as recited in claim 15, wherein said hub closely fits within an aperture defined by said first brake rotor portion and said second brake rotor portion.

18. A disc brake assembly comprising:
a hub defining an axis of rotation, said hub comprising a first, a second, a third and a fourth extension which extend radially relative said axis of rotation;
a first brake rotor portion comprising a first pair of abutments which engage said first extension;
a second brake rotor portion comprising a second pair of abutments which engage said second extension, said second brake rotor portion joined to said first brake rotor portion about said axis of rotation along an offset parting line located adjacent one of a third pair of abutments and one of a fourth pair of abutments, said one of said third pair of abutments extending from said first brake portion and said one of said fourth pair of abutments extending from said second brake portion.
a spring clip located between each of said pair of abutments and a cantilever end of one of said extensions received therebetween.

19. The disc brake assembly as recited in claim 18, wherein said first brake rotor portion and said second brake rotor portion float relative said hub upon said spring clips.

20. The disc brake assembly as recited in claim 18, wherein said spring clips are generally shaped as a }.

21. The disc brake assembly as recited in claim 18, wherein said first brake rotor portion and said second brake rotor portion define a clearance about said hub.
